(19) United States
(12) Patent Application Publication
(10) Pub. No.: US 2014/0218598 A1
(43) Pub. Date: Aug. 7, 2014

(54) LENS ASSEMBLY APPLICABLE TO AN IMAGE SENSOR

(71) Applicant: POWER LENS TECHNOLOGY INC., Hsinchu County (TW)

(72) Inventors: Yi Chao Yeh, Hsinchu County (TW); Jyh Long Chern, Hsinchu County (TW)

(73) Assignee: POWER LENS TECHNOLOGY INC., Hsinchu County (TW)

(21) Appl. No.: 13/761,159

(22) Filed: Feb. 7, 2013

(51) Int. Cl. G02B 9/10; G02B 13/00

(52) U.S. Cl. CPC G02B 9/10; G02B 13/003
USPC 348/360

(57) ABSTRACT

A lens assembly includes a first lens including a first convex surface facing the object side, a first concave surface with an aperture stop facing the image side; a second lens including a second convex surface facing the object side and a second concave surface facing the image side; a first lens further including. Defining that f, f1, f2 are a focal length of the lens assembly, the first lens, and the second lens; D is a distance between the first lens and the second lens; TTL is a total track length; R1 is a radius of the first convex surface; R2 is a radius of the first concave surface; R3 and R4 are respectively radius of the second convex surface and the second concave surface; and Φ is the image circle; the following conditions are satisfied: 0.01<|f/f2|<0.2; 0.1<R1/f1<0.5; 0.8<f1/TTL<1.1; 0.2<D/f<0.5; 0.3<R2/Φ<0.7; and 0.03<(R3−R4)/(R3+R4)<0.3.

### BACKGROUND OF THE INVENTION

1. Field of the Invention

The present invention relates to a lens assembly applicable to an image sensor, and more particularly to a lens assembly applicable to an image sensor composes of two lens elements; and such lens assembly has the features of smaller size and image quality with well corrected aberration.

2. Related Art

In recent years, as digital imaging technology and production process technology of electronic components continue to evolve, a digital imaging lens not is only used in digital camera-related products, but also becomes indispensable equipment in Tablet computers, laptops or smart phones, and other porTable electronic devices.

At the same time, the demand with smaller size for a porTable electronic device has grown remarkably and an imaging lens used in such a porTable electronic device also needs to be miniaturized. As a production process on the complementary metal-oxide semiconductor (CMOS) and the charge-coupled device (CCD) develops continuously, the size of a lens assembly applicable to CMOS or CCD sensor could be reduced. For example, a pixels size of two million pixels (2M Pixels) CMOS sensor is 2.25 μm in the early stage and then reduces to 1.75 μm, and now further reduces to the current 1.4 μm. Also, the size of CMOS sensor is from ¼″ (2.25 μm) to ⅕″ (1.75 μm), and further down to ⅙″ (1.4 μm). Therefore, the same size of a single wafer will get an increased number of CMOS sensors and manufacturers can effectively reduce the price of CMOS sensor. However, how to make a lens assembly with smaller size applied to the image sensor and keep high image quality is the target to be achieved.

Generally, an optical lens system for taking image in the art, such as the one disclosed in U.S. Pat. No. 7,436,604. U.S. Pat. No. 7,436,604 provides an optical lens system with two lens element structure. The optical lens system comprises, from the object side to the image side, a first lens element, a second lens element, and an aperture stop. The first lens element has positive refractive power, and the first lens element also has a convex surface toward the object side and a concave surface toward the image side. The two opposite surfaces of the first lens element are aspheric. The second lens element has negative refractive power, and the second lens element has a concave surface toward the object side and a concave surface toward the image side. The aperture stop is located in front of the first lens element. Though the aforementioned two lens element, most of aberrations except distortion are corrected. However, such a lens system requires a longer total track length.

### SUMMARY OF THE INVENTION

The present invention provides a more practical design to shorten the lens assembly while using a combination of refractive power, convex surfaces and stop location to reduce the total track length and to improve optical aberrations, especially distortion.

To solve the problem of small size and image quality, the present invention is to provide a lens assembly applicable to an image sensor composes of two lens elements, which is smaller in size and whose aberration is well corrected.

The lens assembly of the present invention is applicable to an image sensor and has smaller size and image quality with well corrected aberration, so as to promote the image quality to meet requirement for 1080P sensor.

The lens assembly applicable to an image sensor includes, in order from the object side to the image side, a first lens with positive refractive power and a second lens with negative refractive power. The first lens has a first convex surface toward the object side and a first concave surface toward the image side. The second lens has a second convex surface toward the object side and a second concave surface toward the image side. The first lens further has an aperture stop formed on the first concave surface.

Defining f is a focal length of the lens assembly; f1 is the focal length of the first lens; f2 is the focal length of the second lens; D is a distance between the first lens and the second lens; TTL is a total track length of the lens assembly; R1 is a radius of the first convex surface; R2 is a radius of the first concave surface; R3 and R4 are respectively radius of the second convex surface and the second concave surface; Φ is an image circle; and the following conditions are satisfied:

0.01<|f/f2|<0.2

0.1<R1/f1<0.5

0.8<f1/TTL<1.1

0.2<D/f<0.5

0.3<R2/Φ<0.7 and

0.03<(R3−R4)/(R3+R4)<0.3.

In one or more embodiments of the present invention, one of the second convex surface and the second concave surface of the second lens is aspheric.

In one or more embodiments of the present invention, the cross-section of the second lens is meniscus.

In one or more embodiments of the present invention, the first lens and the second lens are respectively made of plastic, polymer, or glass.

In one or more embodiments of the present invention, the total track length is 2 mm to 4 mm.

In one or more embodiments of the present invention, a filter is disposed between the second lens and the image sensor.

In one or more embodiments of the present invention, the filter is an IR-Cut Filter.

In one or more embodiments of the present invention, a protective glass sheet is disposed between the filter and the image sensor.

The object of the present invention is to obtain image quality with well corrected aberration according to the following relations:

0.01<|f/f2|<0.2;

0.1<R1/f1<0.5;

0.8<f1/TTL<1.1;

0.2<D/f<0.5;

0.3<R2/Φ<0.7; and

0.03<(R3−R4)/(R3+R4)<0.3.

The present invention will become more obvious from the following description of the preferred embodiments taken in conjunction with the accompanying drawings.

### BRIEF DESCRIPTION OF THE DRAWINGS

The present invention will become more fully understood from the detailed description given herein below for illustration only, and thus not limitative of the present invention, wherein:

FIG. 1 is a schematic view of a lens assembly of the present invention.

FIG. 2 is a graph of ray aberration curves of the lens assembly according to a first embodiment.

FIG. 3 is a graph of astigmatism, distortion and longitudinal spherical aberration measurements of the lens assembly according to the first embodiment.

FIG. 4 is a graph of ray aberration curves of the lens assembly according to a second embodiment

FIG. 5 is a graph of astigmatism, distortion and longitudinal spherical aberration measurement of the lens assembly according to the second embodiment.

FIG. 6 is a graph of ray aberration curves of the lens assembly according to a third embodiment.

FIG. 7 is a graph of astigmatism, distortion and longitudinal spherical aberration measurements of the lens assembly according to the third first embodiment.

### DETAILED DESCRIPTION OF THE INVENTION

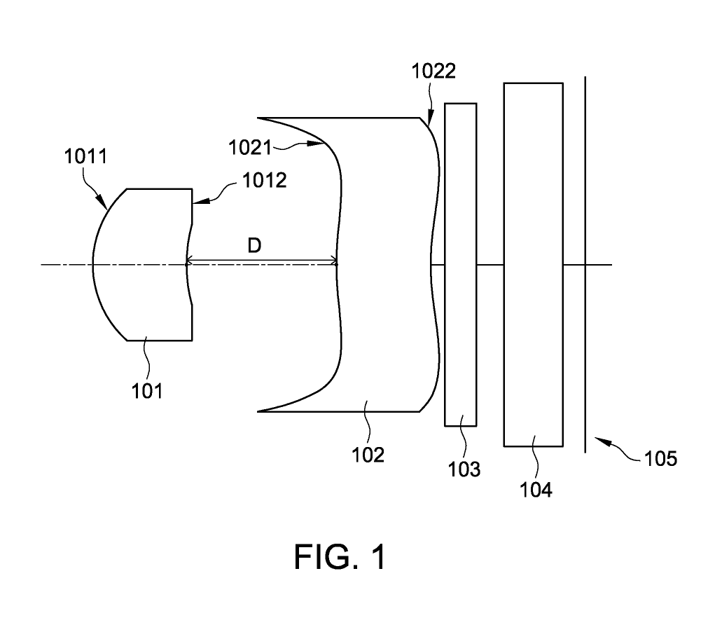

FIG. 1 shows a lens assembly 10 applicable to an image sensor 105 in accordance with the present invention. The lens assembly captures image from the object side and imaging on the image sensor 105 at the image side. Preferably, the image sensor 105 is a 1080P image sensor, and the total track length of the lens assembly is 2 mm to 4 mm.

With reference to FIG. 1, the lens assembly includes a first lens 101, a second lens 102, a filter 103, a protective glass sheet 104 and an image sensor 105 in order from the object side to the image side along an optical axis.

Referring to FIG. 1, the first lens 101 has a first convex surface 1011 toward the object side and a first concave surface 1012 toward the image side. The second lens 102 has a second convex surface 1021 toward the object side and a second concave surface 1022 toward the image side. Furthermore, the lens assembly 10 includes an aperture stop located on the first concave surface 1012.

As stated above, one of the second convex surface 1021 and the second concave surface 1022 of the second lens is aspheric and the cross-section of the second lens is meniscus. The second convex surface 1021 and the second concave surface 1022 satisfy the aspheric surface formula as follows:

$$z = \frac{{ch}^{2}}{1 + \sqrt{1 - ( 1 + K ) {c}^{2} {h}^{2}}} + {\sum }_{i} {A}_{i} {h}^{i} ;$$

wherein,

z is the relative height from a point on the aspheric surface to a tangent plane at the top of the optical axis of the aspheric surface;

h is the distance between the point on the curve of the aspheric surface to the optical axis;

c is a curvature of the corresponding surface;

K is conic constant; and

Ai is the ith order of the aspheric coefficient of the corresponding surface.

A filter 103 is disposed between the second lens 102 and the image sensor 105. The effect of the filter 103 is to filter part of rays such that the better image is obtained on an image sensor through the lens assembly 10. An example of the filter 103 is IR-cut filter which could filter infrared rays.

A protective glass sheet 104 is disposed between the filter 103 and the image sensor 105 and used to protect the image sensor 105.

A first lens 101 and a second lens 102 are respectively made of plastic, polymer, or glass.

An image sensor 105 is one of CMOS, CCD or other photodetectors.

In the aforementioned lens assembly 10, the incident rays pass through the first lens 101, the second lens 102, the filter 103 and the protective glass sheet 104 and focus on the image sensor 105 in order to form an imaging system.

In the present lens assembly 10, f is a focal length of the lens assembly 10; f1 is the focal length of the first lens 101; f2 is the focal length of the second lens 102; D is a distance between the first lens 101 and the second lens 102; TTL is a total track length of the lens assembly 10; R1 is a radius of the first convex surface 1011; R2 is a radius of the first concave surface 1012; R3 and R4 are respectively radius of the second convex surface 1021and the second concave surface 1022; Φ is an image circle; the present invention is to obtain image quality with well corrected aberration according to the following relations:

0.01<|f/f2|<0.2 (1)

0.1<R1/f1<0.5 (2)

0.8<f1/TTL<1.1 (3)

0.2<D/f<0.5 (4)

0.3<R2/Φ<0.7 an (5)

0.03<(R3−R4)/(R3+R4)<0.3 (6)

Preferred embodiments of the present lens assembly 10 will be described in the following paragraphs by referring to the accompanying drawings.

In the following Tables, the symbol φ is the image circle, F/# is the f number, and the focal length of the entire lens assembly is denoted as f. HFOV denotes a half of the maximum view angle, r corresponds to the radius of curvature, d designates the lens element thickness or a distance between lens elements, N_{d} is the refractive index of the d-line and d designates the Abbe number.

In the following embodiments of the lens assembly 10, the optical parameters in the first lens 101 and the second 102 satisfy the formula (1) to (6).

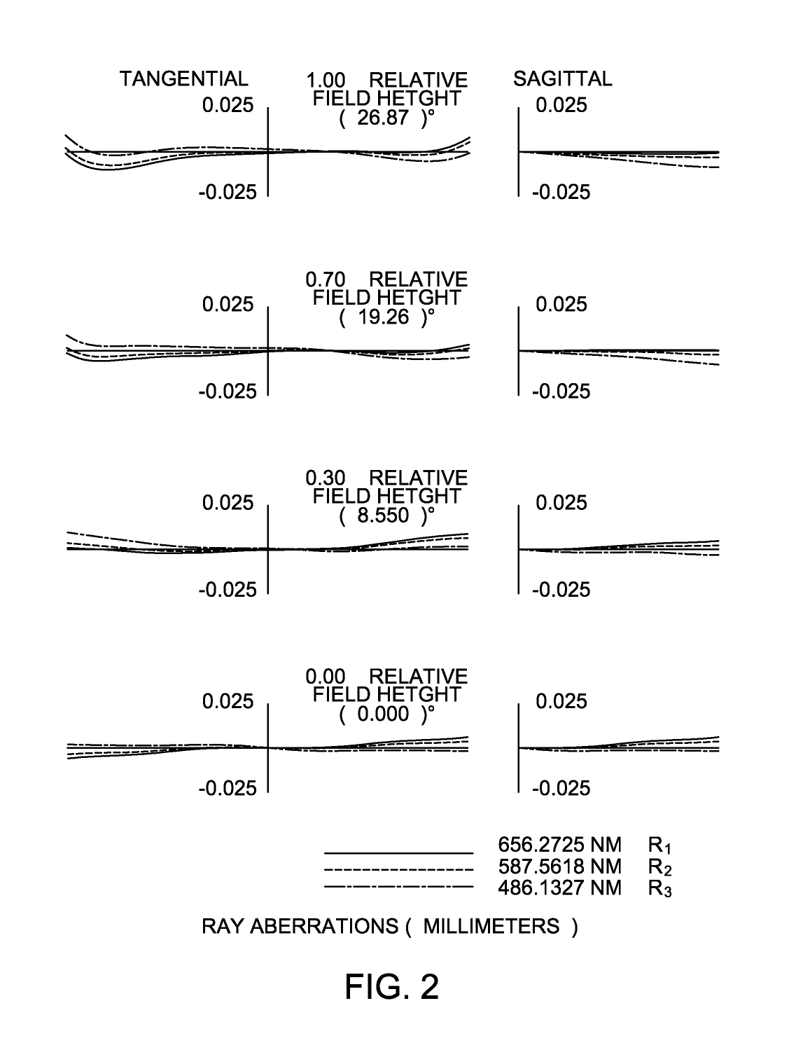

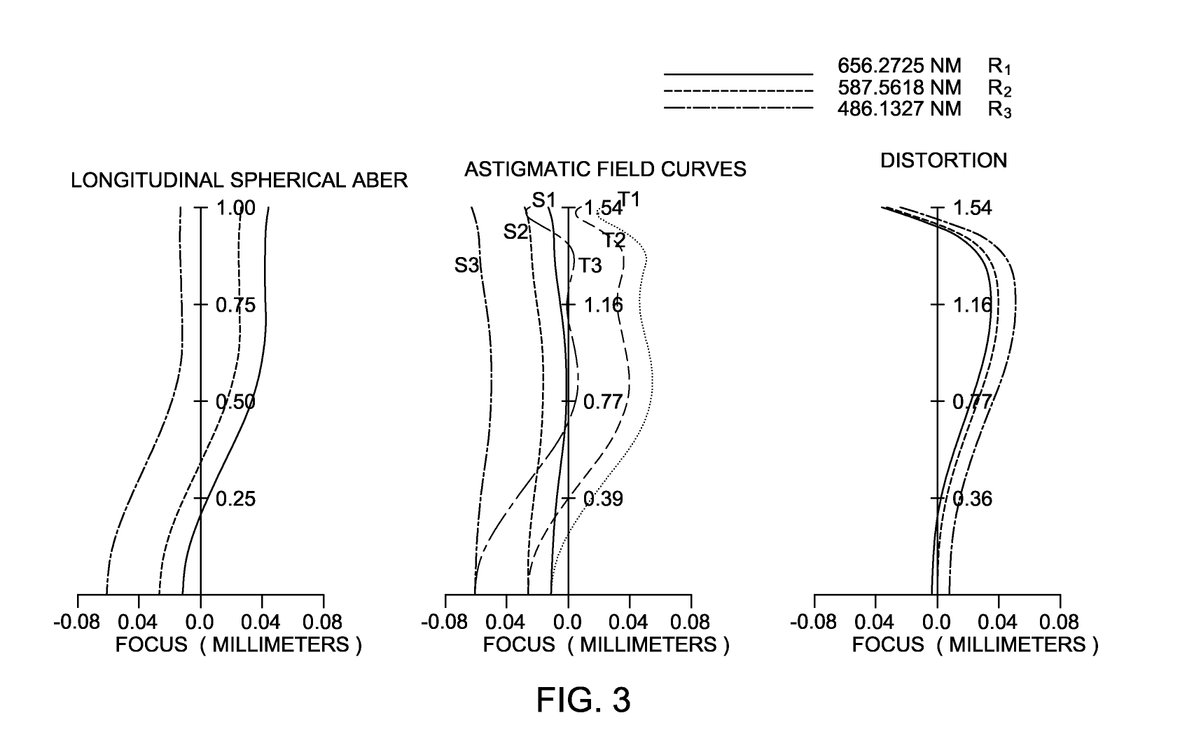

FIG. 1 shows a lens assembly in accordance with the present invention, FIG. 2 shows ray aberration curves of the first embodiment of the present invention and FIG. 3 shows astigmatism, distortion and longitudinal spherical aberration measurements of the first embodiment of the present invention. The detailed optical data of the first embodiment is shown in the Table 1, and the aspheric surface data is shown in Table 2.

TABLE 1
Lens Data
Φ = 3.084
F/# = 2.8
f = 3.0088
HFOV = 26.8653°

| Surf. No. | r | d | Nd | Vd |
|---|---|---|---|---|
| Object side of the first | 0.9924 | 0.6861 | 1.543 | 56 |
| lens 101 | | | | |
| Image side of the first | 1.7429 | 1.0203 | — | — |
| lens 101 | | | | |
| Object side of the second | 2.8939 | 0.6564 | 1.53 | 56 |
| lens 102 | | | | |
| Image side of the second | 2.4161 | 0.1039 | — | — |
| lens 102 | | | | |
| Object side of the filter | ∞ | 0.21 | 1.5231 | 55 |
| 103 | | | | |
| Image side of the filter | ∞ | 0.2 | — | — |
| 103 | | | | |
| Object side of the | ∞ | 0.4 | 1.5168 | 64.16641 |
| protective glass sheet 104 | | | | |
| Image side of the | ∞ | 0.157 | — | — |
| protective glass sheet 104 | | | | |

TABLE 2

| Surf. No. | Parameters of aspheric surfaces |
|---|---|
| Object side of the first | K = −0.1216; |
| lens 101 | A4 = −5.8926E−02; A6 = 6.6656E−01; |
| | A8 = −1.6182+00; A10 = 1.7113+00 |
| Image side of the first | K = 6.9845; |
| lens 101 | A4 = 6.1314E−02 |
| Object side of the second | K = −15.9124; |
| lens 102 | A4 = −2.6589E−01; A6 = 2.9461E−01; |
| | A8 = −2.6151E−01 |
| Image side of the second | K = −26.4802; |
| lens 102 | A4 = −7.9050E−02; A6 = −3.7891E−02; |
| | A8 = 9.2195E−02; A10 = −1.3155E−01; |
| | A12 = 8.6725E−02; A14 = −1.9946E−02; |
| | A16 = −1.0471E−02; A18 = 5.1550E−03; |
| | A20 = −1.18E−04 |

FIG. 2 shows tangential field aberrations and sagittal field aberrations with reference to the R1 line (wavelength of 656.2725 nm), the R2 line (wavelength of 587.5618 nm), and the R3 line (wavelength of 486.1327 nm). According to FIG. 2, the lens assembly 10 controls the values of tangential field aberrations and sagittal field aberrations within the −0.025 mm˜0.025 mm.

FIG. 3 shows longitudinal spherical aberration, astigmatism field curve, and distortion with reference to the R1 line (wavelength of 656.2725 nm), the R2 line (wavelength of 587.5618 nm), and the R3 line (wavelength of 486.1327 nm). According to FIG. 3, the lens assembly 10 controls the longitudinal spherical aberration within the −0.08 mm˜0.08 mm, astigmatism within the −0.08 mm˜0.08 mm, and distortion within −1.0%˜1.0%.

As stated above, the lens assembly 10 in accordance with the first embodiment of the present invention provides high image quality (HFOV=26.8653°).

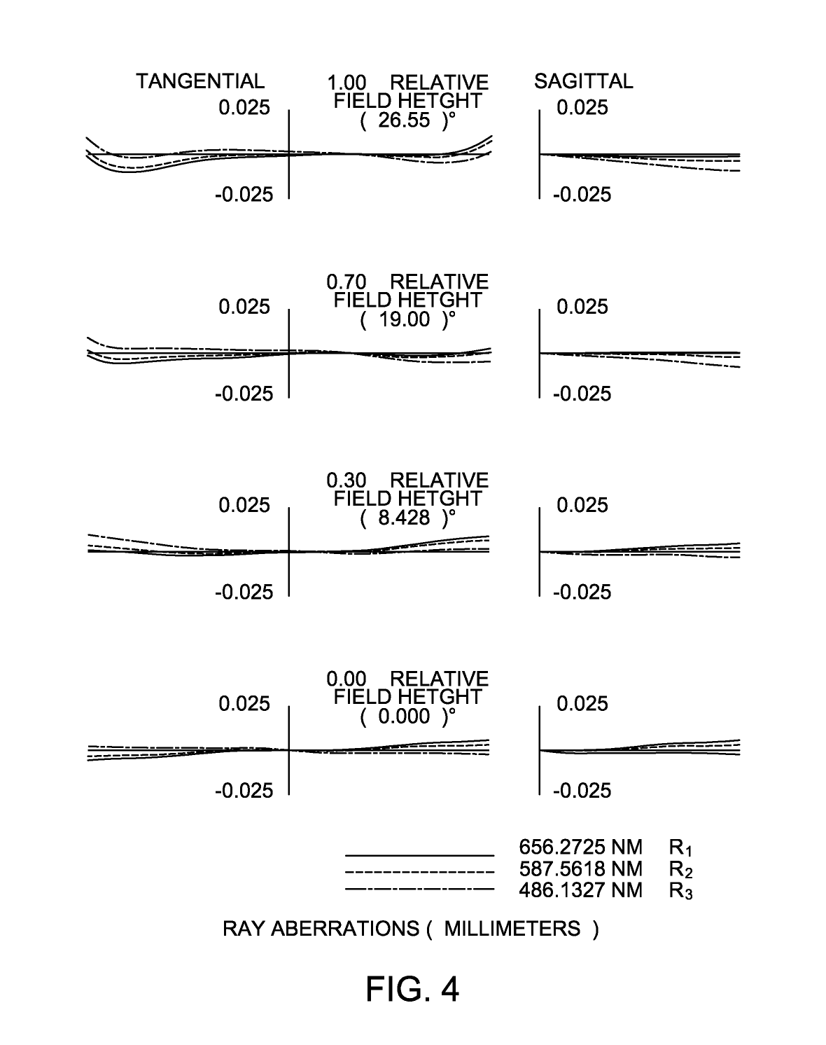

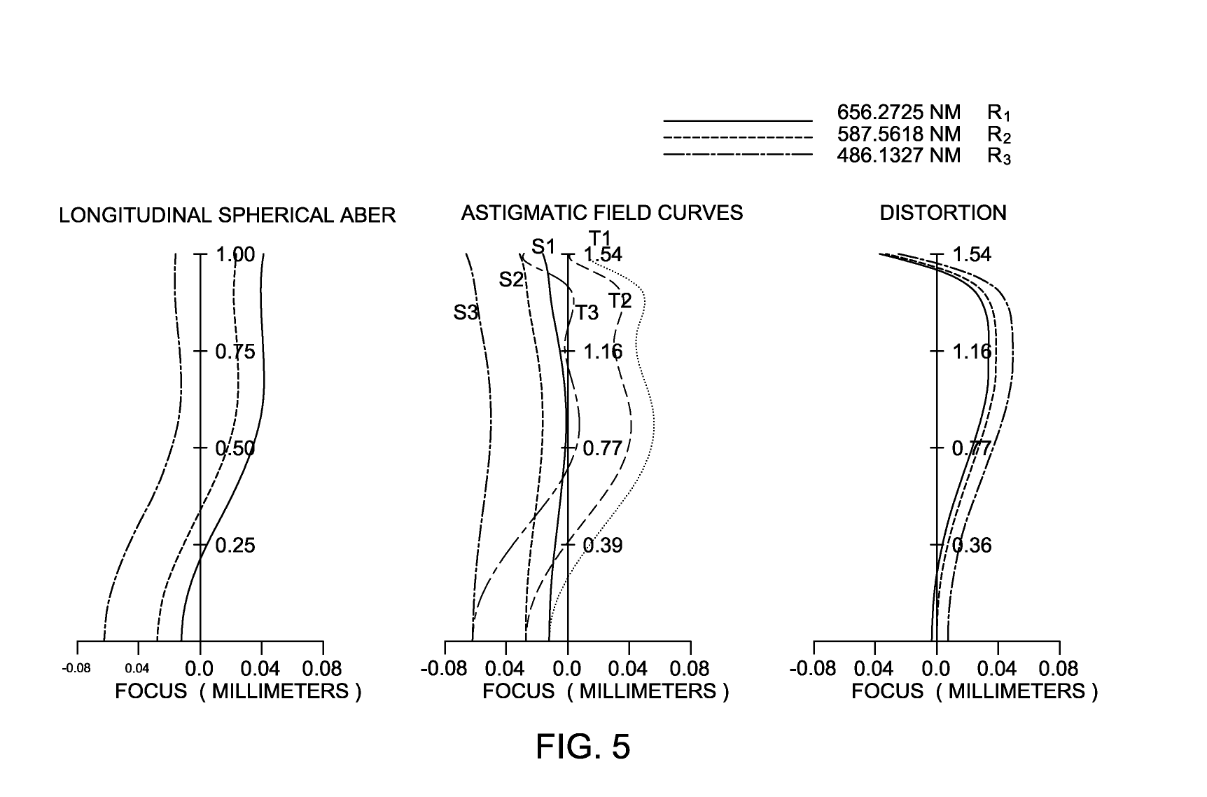

FIG. 4 shows ray aberration curves of the second embodiment of the present invention and FIG. 5 shows astigmatism, distortion and longitudinal spherical aberration measurements of the second embodiment of the present invention. The detailed optical data of the second embodiment is shown in the Table 3, and the aspheric surface data is shown in Table 4.

TABLE 3
Lens Data
Φ = 3.084
F/# = 2.8
f = 3.0453
HFOV = 26.5512°

| Surf. No. | r | d | Nd | Vd |
|---|---|---|---|---|
| Object side of the first | 0.9842 | 0.7105 | 1.515 | 57 |
| lens 101 | | | | |
| Image side of the first | 1.8001 | 1.0600 | — | — |
| lens 101 | | | | |
| Object side of the second | 2.3802 | 0.5918 | 1.49 | 55.3 |
| lens 102 | | | | |
| Image side of the second | 1.9775 | 0.1206 | — | — |
| lens 102 | | | | |
| Object side of the filter | ∞ | 0.21 | 1.5231 | 55 |
| 103 | | | | |
| Image side of the filter | ∞ | 0.2 | — | — |
| 103 | | | | |
| Object side of the | ∞ | 0.4 | 1.5168 | 64.16641 |
| protective glass sheet 104 | | | | |
| Image side of the | ∞ | 0.157 | — | — |
| protective glass sheet 104 | | | | |

TABLE 4

| Surf. No. | Parameters of aspheric surfaces |
|---|---|
| Object side of the first | K = −0.1470; |
| lens 101 | A4 = −6.4744E−02; A6 = 6.7813E−01; |
| | A8 = −1.6009+00; A10 = 1.6460E+00 |
| Image side of the first | K = 7.5683; |
| lens 101 | A4 = 6.5477E−02 |
| Object side of the second | K = −12.2028; |
| lens 102 | A4 = −2.8438E−01; A6 = 3.1459E−01; |
| | A8 = −2.5793E−01 |
| Image side of the second | K = −17.5268; |
| lens 102 | A4 = −9.1446E−02; A6 = −3.2346E−02; |
| | A8 = 9.1548E−02; A10 = −1.3197E−01; |
| | A12 = 8.6081E−02; A14 = −2.0024E−02; |
| | A16 = −1.0680E−02; A18 = 5.1583E−03; |
| | A20 = −6.8718E−05 |

FIG. 4 shows tangential field aberrations and sagittal field aberrations with reference to the R1 line (wavelength of 656.2725 nm), the R2 line (wavelength of 587.5618 nm), and the R3 line (wavelength of 486.1327 nm). According to FIG. 4, the lens assembly 10 controls the values of tangential field aberrations and sagittal field aberrations within the −0.025 mm˜0.025 mm.

FIG. 5 shows longitudinal spherical aberration, astigmatism field curve, and distortion with reference to the R1 line (wavelength of 656.2725 nm), the R2 line (wavelength of 587.5618 nm), and the R3 line (wavelength of 486.1327 nm). According to FIG. 5, the lens assembly 10 controls the longitudinal spherical aberration within the −0.08 mm˜0.08 mm, astigmatism within the −0.08 mm˜0.08 mm, and distortion within −1.0%˜1.0%.

As stated above, the lens assembly 10 in accordance with the second embodiment of the present invention provides high image quality (HFOV=26.5512°).

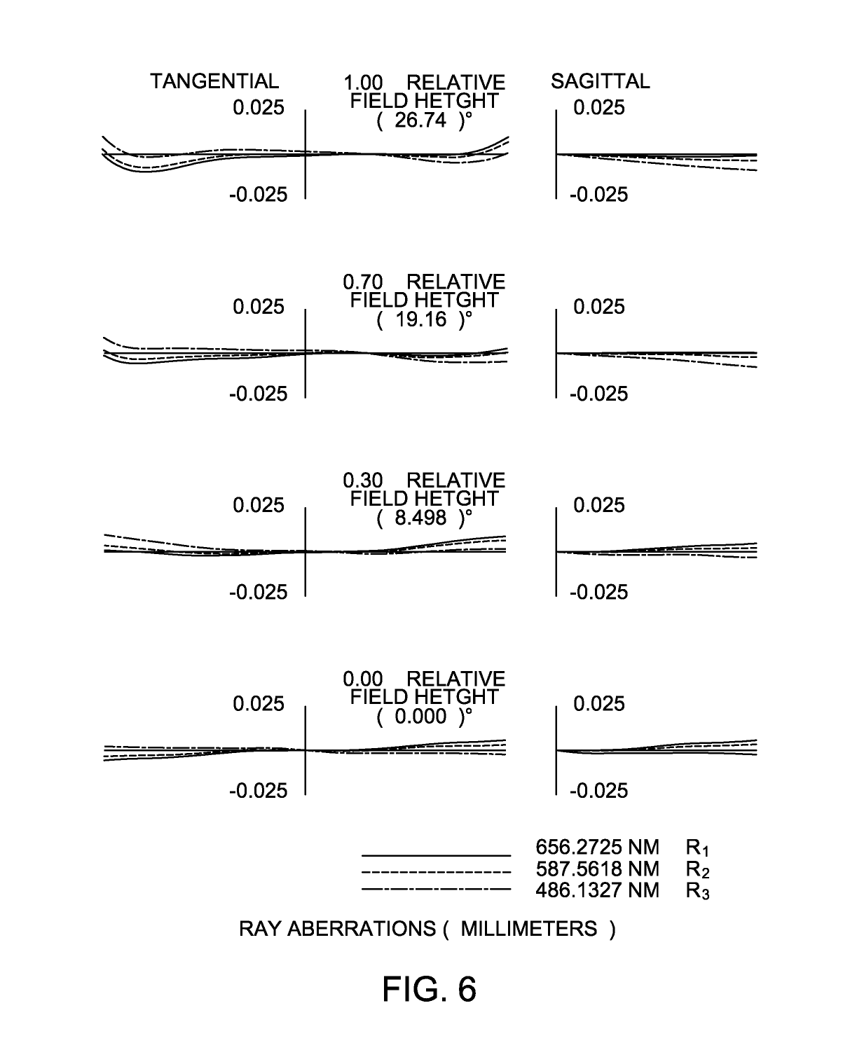

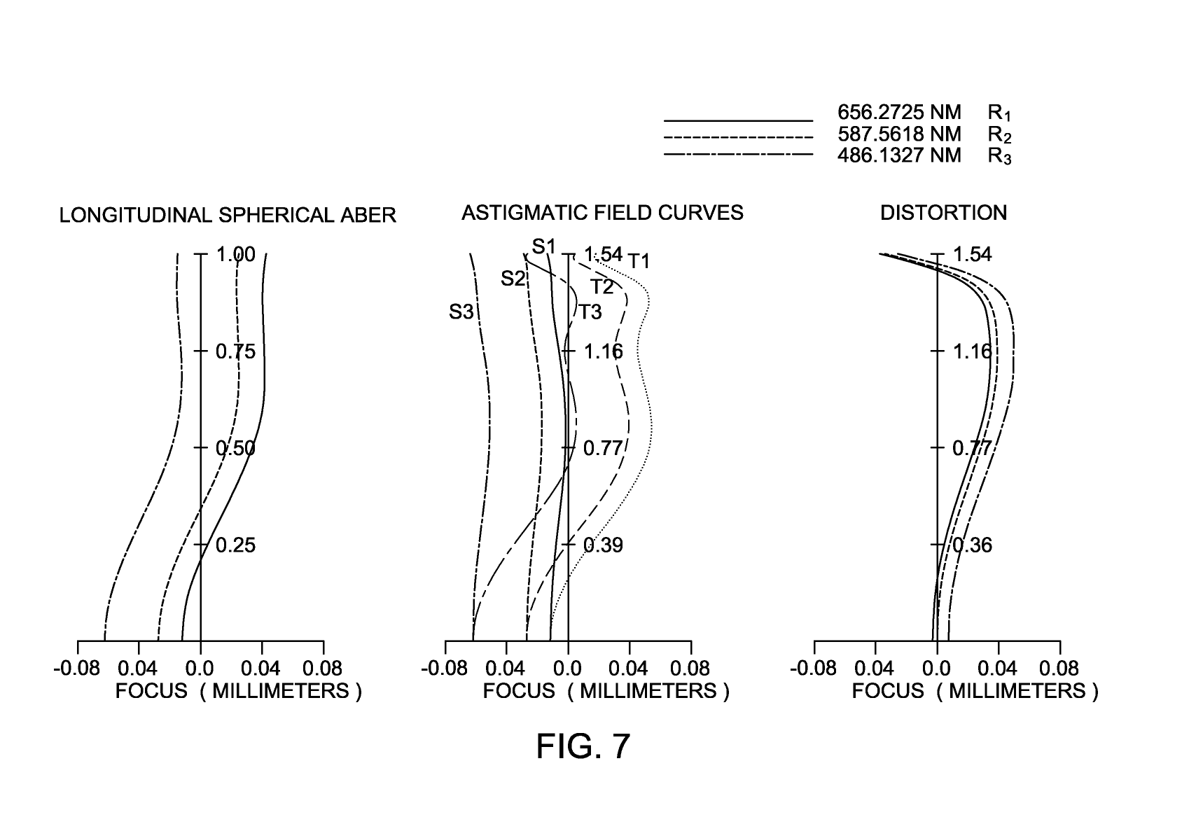

FIG. 6 shows ray aberration curves of the third embodiment of the present invention and FIG. 7 shows astigmatism, distortion and longitudinal spherical aberration measurements of the third embodiment of the present invention. The detailed optical data of the third embodiment is shown in the Table 5, and the aspheric surface data is shown in Table 6.

TABLE 5
Lens Data
Φ = 3.084
F/# = 2.8
f = 3.022
HFOV = 26.7372°

| Surf. No. | R | d | Nd | Vd |
|---|---|---|---|---|
| Object side of the first | 0.9925 | 0.6894 | 1.53 | 56 |
| lens 101 | | | | |
| Image side of the first | 1.7906 | 1.0417 | — | — |
| lens 101 | | | | |
| Object side of the second | 2.6751 | 0.6402 | 1.515 | 57 |
| lens 102 | | | | |
| Image side of the second | 2.2335 | 0.1 | — | — |
| lens 102 | | | | |
| Object side of the filter | ∞ | 0.21 | 1.5231 | 55 |
| 103 | | | | |
| Image side of the filter | ∞ | 0.2 | — | — |
| 103 | | | | |
| Object side of the | ∞ | 0.4 | 1.5168 | 64.16641 |
| protective glass sheet 104 | | | | |
| Image side of the | ∞ | 0.157 | — | — |
| protective glass sheet 104 | | | | |

TABLE 6

| Surf. No. | Parameters of aspheric surfaces |
|---|---|
| Object side of the first | K = −0.1282; |
| lens 101 | A4 = −6.0185E−02; A6 = 6.7178E−01; |
| | A8 = −1.6224E+00; A10 = 1.7013E+00 |
| Image side of the first | K = 8.2422; |
| lens 101 | A4 = 6.2121E−02; A6 = −1.7454E−01; |
| Object side of the second | K = −14.5976; |
| lens 102 | A4 = −2.6334E−01; A6 = 2.9094E−01; |
| | A8 = −2.5179E−01 |
| Image side of the second | K = −21.8725; |
| lens 102 | A4 = −8.2999E−02; A6 = −3.1032E−02; |
| | A8 = 8.8752E−02; A10 = −1.3253E−01; |
| | A12 = 8.7990E−02; A14 = −1.9719E−02; |
| | A16 = −1.0672E−02; A18 = 4.8973E−03 |

FIG. 6 shows tangential field aberrations and sagittal field aberrations with reference to the R1 line (wavelength of 656.2725 nm), the R2 line (wavelength of 587.5618 nm), and the R3 line (wavelength of 486.1327 nm). According to FIG. 6, the lens assembly 10 controls the values of tangential field aberrations and sagittal field aberrations within the −0.025 mm˜0.025 mm.

FIG. 7 shows longitudinal spherical aberration, astigmatism field curve, and distortion with reference to the R1 line (wavelength of 656.2725 nm), the R2 line (wavelength of 587.5618 nm), and the R3 line (wavelength of 486.1327 nm). According to FIG. 7, the lens assembly 10 controls the longitudinal spherical aberration within the −0.08 mm˜0.08 mm, astigmatism within the −0.08 mm˜0.08 mm, and distortion within −1.0%˜1.0%.

As stated above, the lens assembly 10 in accordance with the third embodiment of the present invention provides high image quality (HFOV=26.7372°).

What is claimed is:

1. A lens assembly applicable to an image sensor, for capturing image from an object side and imaging on the image sensor, the lens assembly comprising a first lens and a second lens, wherein the first lens and the second lens are disposed in an optical axis in order from the object side, and the lens assembly is characterized in that:
the first lens includes positive refractive power, and the first lens further includes a first convex surface facing the object side and a first concave surface facing the image side;
the second lens includes negative refractive power, and the second lens further includes a second convex surface facing the object side and a second concave surface facing the image side;
the lens assembly further comprises an aperture stop, disposed on the first concave surface;
wherein, f is a focal length of the lens assembly; f1 is focal length of the first lens; f2 is the focal length of the second lens; D is a distance between the first lens and the second lens; TTL is a total track length of the lens assembly; R1 is a radius of the first convex surface; R2 is a radius of the first concave surface; R3 and R4 are respectively radius of the second convex surface and the second concave surface; and Φ is the image circle the following conditions are satisfied:
0.01<|f/f2|<0.2;
0.1<R1/f1<0.5;
0.8<f1/TTL<1.1;
0.2<D/f<0.5;
0.3<R2/Φ<0.7; and
0.03<(R3−R4)/(R3+R4)<0.3.

2. The lens assembly as claimed in claim 1, wherein one of the second convex surface and the second concave surface of the second lens is aspheric.

3. The lens assembly as claimed in claim 2, wherein the cross-section of the second lens is meniscus.

4. The lens assembly as claimed in claim 1, wherein the first lens and the second lens are respectively made of plastic, polymer, or glass.

5. The lens assembly as claimed in claim 1, wherein TTL is 2 mm to 4 mm.

6. The lens assembly as claimed in claim 1, further comprising a filter, disposed between the second lens and the image sensor.

7. The lens assembly as claimed in claim 6, wherein the filter is an IR-Cut Filter.

8. The lens assembly as claimed in claim 6, further comprising a protective glass sheet, disposed the filter and the image sensor.
